(19) United States
(12) Patent Application Publication
(10) Pub. No.: US 2023/0126358 A1
(43) Pub. Date: Apr. 27, 2023

(54) REDOX SHUTTLE ASSISTED ELECTRODEIONIZATION

(71) Applicant: PALO ALTO RESEARCH CENTER INCORPORATED, Palo Alto, CA (US)

(72) Inventors: Brian Kienitz, Mountain View, CA (US); McLain Leonard, Palo Alto, CA (US); Aravindh Rajan, Palo Alto, CA (US)

(21) Appl. No.: 17/946,452

(22) Filed: Sep. 16, 2022

Related U.S. Application Data
(60) Provisional application No. 63/270,660, filed on Oct. 22, 2021.

(51) Int. Cl. C02F 1/469; C02F 1/461

(52) U.S. Cl. CPC C02F 1/4695; C02F 1/46109; C02F 2103/08

(57) ABSTRACT

The present disclosure is directed to an electrodialytic stack with a concentrate stream that moves through a concentrate flow path bounded by a central ion exchange membrane and a first outer ion exchange membrane. A dilute stream moves through a dilute flow path bounded by the central ion exchange membrane and a second outer ion exchange membrane. A redox shuttle loop is separated from the concentrate and dilute streams by the first and second outer ion exchange membranes, respectively. The outer ion exchange membranes are a different type than the central ion exchange membrane. Electrodes are operable to apply a voltage across the stack. At least one collection of ion exchange materials is located in at least one of the flow paths. The ion exchange materials migrate ions between the central ion exchange membrane and at least one of the outer ion exchange membranes.

### RELATED APPLICATIONS

This application claims the benefit of U.S. provisional patent application Ser. No. 63/270,660, filed on Oct. 22, 2021, to which priority is claimed pursuant to 35 U.S.C. § 119(e), and which is incorporated herein by reference in its entirety.

### TECHNICAL FIELD

This disclosure relates generally to desalinization-salinization systems and methods of operating the same.

### BACKGROUND

There is an ever-increasing pressure on supplies of fresh water as a result of climate change and the relentless pace of population growth worldwide. For communities located in areas where there is no ready access to fresh water, such as the Persian Gulf and other desert areas, fresh water is produced through desalinization of seawater. In these locations, this process is highly energy intensive whether it is driven hydraulically (for example, through reverse osmosis), thermally (for example, through flash distillation), or electrochemically (for example, through electrodialysis). Elsewhere, these methods are routinely employed, for example, in treatment of contaminated wastewater from industrial activity, industrial high purity water processing, liquid desiccant regeneration, and industrial brine concentration.

In addition, the price of electricity generation from renewable sources is rapidly falling, driven primarily by technological improvements in solar and wind generation. This ready availability of cheap electrons presents an opportunity for electrochemical methods of water desalinization (or treatment) to play a greater role in meeting the rising demand for water. Described herein are systems and processes that reduce both energy consumption and overall costs for desalinization.

### SUMMARY

The present disclosure is generally related to electrochemical salinization and desalinization systems. Electrochemical approaches to desalinization have the potential to scale modularly and ramp production easily, while maintaining high energetic efficiency. They further have the ability to process high-salinity feeds, and to desalinate to aqueous solutions to ultrapure levels.

An electrodialytic stack includes a concentrate flow path bounded by a central ionic exchange membrane and a first outer ionic exchange membrane of a different type than the central ionic exchange membrane. A concentrate stream moves through the concentrate flow path. A dilute flow path is bounded by the central ionic exchange membrane and a second outer ionic exchange membrane of a different type than the central ionic exchange membrane. A dilute stream moves through the dilute flow path. A redox shuttle loop is separated from the concentrate stream by the first outer ionic exchange membrane and separated from the dilute stream by the second outer ionic exchange membrane. A first electrode and a second electrode are operable to apply a voltage across the electrodialytic stack. At least one collection of ion exchange materials is in at least one of the concentrate flow path or the dilute flow path. The at least one collection of ion exchange materials migrates ions between the central ionic exchange membrane and at least one of the first and second outer ionic exchange membranes.

Another electrodialysis system includes at least one electrodialytic stack. Each electrodialytic stack includes a concentrate flow path having a concentrate inlet in fluid communication with a concentrate outlet. The concentrate flow path is bounded by a central ionic exchange membrane and a first outer ionic exchange membrane of a different type than the central ionic exchange membrane. A concentrate stream moves through the concentrate flow path. A dilute flow path includes a dilute inlet in fluid communication with a dilute outlet. The dilute flow path is bounded by the central ionic exchange membrane and a second outer ionic exchange membrane of a different type than the central ionic exchange membrane. A dilute stream moves through the dilute flow path. A feed flow path is in fluid communication with one or both of the concentrate inlet and the dilute inlet. A redox shuttle loop is separated from the concentrate stream by the first outer ionic exchange membrane. The redox shuttle loop is separated from the dilute stream by the second outer ionic exchange membrane. A first electrode and a second electrode are operable to apply a voltage across the electrodialytic stack. At least one collection of ion exchange materials is in at least one of the concentrate flow path or the dilute flow path. The at least one collection of ion exchange materials migrates ions between the central ionic exchange membrane and at least one of the first and second ionic exchange membranes. The feed flow path is configured to be coupled to one or both of the concentrate outlet and the dilute outlet.

A method includes inputting a concentrate stream into a concentrate flow path of an electrodialytic stack and inputting a dilute stream into a dilute flow path of the electrodialytic stack. The concentrate flow path is bounded by a first outer ionic exchange membrane and a central ionic exchange membrane. The dilute flow path is bounded by a second outer ionic exchange membrane and the central ionic exchange membrane. Then circulating a redox shuttle loop around the first and second outer ionic exchange membranes, and applying a voltage across the electrodialytic stack, for migrating ions between the central ionic exchange membrane and one or both of the first and second ionic exchange membranes via at least one collection of ion exchange materials in one or both of the concentrate flow path and the dilute flow path.

Embodiments described herein may surprisingly provide an up to or greater than four-fold improvement on the efficiency of other electrochemical methods of water desalinization, when measured in kilograms of water (for example, sea water) desalinated per kilowatt-hour.

### BRIEF DESCRIPTION OF THE DRAWINGS

The discussion below makes reference to the following figures, wherein the same reference number may be used to identify the similar/same component in multiple figures. The figures are not necessarily to scale.

FIG. 1 is a schematic diagram of a redox shuttle assisted electrodialysis cell/stack;

FIG. 2 is a schematic diagram of a redox shuttle assisted electrodeionization cell/stack with a redox shuttle loop according to one or more embodiments;

FIGS. 3A and 3B are sechematic diagrams of a four-chambered redox shuttle assisted electrodeionization cell/stack according to one or more embodiments;

FIG. 4 is a flowchart of a method according to one or more embodiments;

FIG. 5 is a block diagram showing a combination of different redox shuttle assisted stacks according to one or more embodiments;

FIGS. 6 and 7 are graphs showing predicted performance of a redox shuttle assisted electrodialysis cell/stack; and

FIGS. 8 and 9 are graphs showing preliminary performance results of a redox shuttle assisted electrodeionization cell/stack compared with performance results of different electrochemical salinization/desalinization systems.

### DETAILED DESCRIPTION

In the following detailed description of illustrative embodiments, reference is made to the accompanying figures which form a part hereof. It is to be understood that other embodiments, which may not be described and/or illustrated herein, are certainly contemplated. Unless otherwise indicated, all numbers expressing quantities, and all terms expressing direction/orientation (for example, vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est, and means “that is.” “E.g.” is used as an abbreviation for the Latin phrase exempli gratia, and means “for example.” It is noted that the terms “comprises” and variations thereof do not have a limiting meaning and are used in their open-ended sense to generally mean “including but not limited to” where these terms appear in the accompanying description and claims. Further, “a,” “an,” “the,” “at least one,” and “one or more” are used interchangeably herein.

The present disclosure is generally related to electrochemical ion transfer systems to transfer ions between streams. More specifically, the present disclosure is related to salinization and desalinization systems. Electrochemical approaches to desalinization have the potential to scale modularly and ramp production easily, while maintaining high energetic efficiency and the ability to process high-salinity feeds. The systems and methods described herein provide surprisingly efficient electrochemical salinization and desalinization, including desalinization of aqueous solutions to ultrapure levels. The systems and methods described herein are additionally or alternatively useful in other applications, such as wastewater processing, industrial high purity water processing, liquid desiccant regeneration, and industrial brine concentration.

One popular form of electrochemical water desalinization is electrodialysis; however, it currently consumes comparatively more energy for salt removal (for example, ˜0.26-0.30 kWh/kg NaCl) than other desalinization techniques like reverse osmosis (for example, 0.06-0.08 kWh/kg NaCl) but less than for thermal techniques like vapor compression (for example, 0.6-1.0 kWh/kg NaCl). Another technique, capacitive deionization, uses electrical energy but is also energy intensive at about 0.22 kWh/kg NaCl and is best suited for removing minute amounts of dissolved salts from water because the electrodes have to be solid, by definition. Electrodialysis is a technique that can be employed to treat brines at any salinity, unlike reverse osmosis, but it has seen limited use because of its high specific energy consumption for salt removal.

Because the energy consumption in electrodialysis is proportional to the applied voltage, reducing (or minimizing) the voltage that has to be applied to a cell will reduce the specific energy consumption of the electrodialytic stack. In conventional electrodialysis, ions are driven out of, or into, water by Faradaic reactions at an anode and a cathode. In most cases, the Faradaic reactions are that of water splitting: water is oxidized to oxygen at the anode and reduced to hydrogen at the cathode. This creates a charge imbalance at the electrodes that is balanced by the movement of ions through strategically placed ion-selective membranes. However, water splitting involves an energetic penalty because energy is required to do so. The problem is exacerbated by the fact that significant overpotentials are associated with both water oxidation and reduction. Moreover, oxygen and chlorine gas generated at the anode are highly destructive and require the use of platinum/iridium-plated electrodes.

An electrochemical cell, also referred to as redox shuttle assisted electrodialysis (RSAE) stack, as described herein, is designed to perform electrodialysis in an energy-efficient manner by circulating a redox-active species (that is, a redox shuttle) dissolved in water from the anode to the cathode and back again. In redox shuttle assisted electrodialysis, the redox shuttle is utilized at the electrodes of an electrodialysis unit instead of electrolyzing water or other solute. This results in much more efficient operation, limits parasitic side reactions, and doesn't require the use of precious group metals. The redox-active species has rapid kinetics for reduction or oxidation, which greatly reduces the high operating voltage required for conventional electrodialysis, in which water splitting drives salt transport across membranes such as ion-selective membranes. Reducing the operating voltage reduces the specific consumption of energy because the specific energy consumption is proportional to the operating voltage.

In certain embodiments of an energy-efficient, low-potential redox shuttle assisted electrodialysis system, the redox carrier (that is, the redox shuttle) that is dissolved in water is reduced at the cathode, then shuttled to the anode where it is reoxidized and subsequently redelivered to the cathode to complete the cycle. In the redox shuttle assisted electrodialysis process, the aqueous solution of the redox-active species is circulated between the anode and cathode of an electrochemical stack to dilute and concentrate ionic solutions.

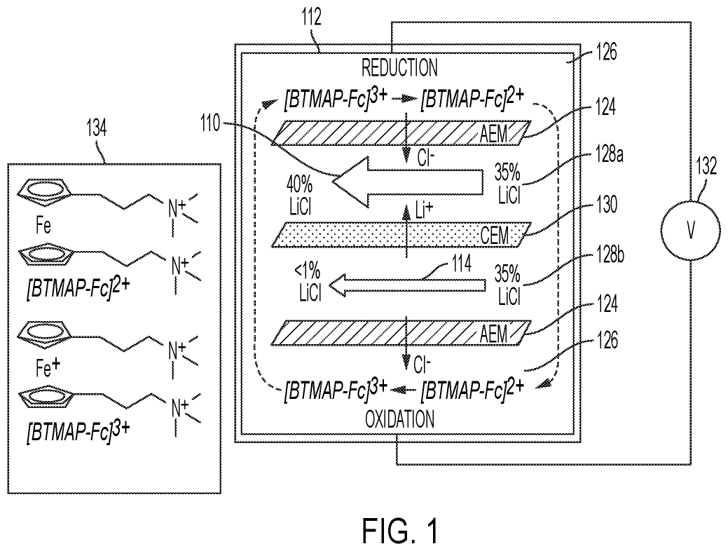

In FIG. 1, a diagram shows features of a redox shuttle assisted electrodialytic stack 112 according to an example embodiment. The redox shuttle assisted electrodialytic stack 112 has two outer ion exchange membranes 124 that separate the outer redox channels 126 from the inner concentrate stream 110 and dilute stream 114. The membranes may be of different types depending upon the cell design, such as ion-selective membranes (for example, cation exchange membranes or anion exchange membranes), microporous membranes (for example, if the redox shuttles have a high enough molecular weight, such as shuttles that are dendrimeric or polymeric in nature), and/or composite membranes. Some types of membranes may incorporate elements of different types, such as incorporating some ion-selective elements and some microporous elements within the same type of membrane. In one or more embodiments, as seen in FIG. 1, the outer ion exchange membranes 124 are configured as anion exchange membranes. Accordingly, the concentrate stream 110 and dilute stream 114 are separated by a central ion exchange membrane 130, which may be a cation exchange membrane in FIG. 1. In other configurations, the central ion exchange membrane 130 may be an anion exchange membrane and the outer ion exchange membranes 124 (that is, the membranes opposing (on the opposite side of the concentrate and dilute fluid pathways to) the central ion exchange membrane) may be cation exchange membranes.

An external voltage 132 induces oxidation and/or reduction in redox-active shuttle molecules, driving ion movement across the membranes 124, 130 without splitting water or producing other gaseous by-products (for example, chlorine) and creating two streams: a concentrate stream 110 and a dilute stream 114 (for example, water). Example redox shuttles may include positively charged redox active species. One such proposed redox shuttle is a positively-charged ferrocene derivative such as (bis(trimethylammoniopropyl)ferrocene/bis(trimethylammoniopropyl) ferrocenium, [BTMAP-Fc]²⁺/[BTMAP-Fc]³⁺) 134, which is non-toxic and highly stable, and has rapid electrochemical kinetics and negligible membrane permeability. Other ferrocene derivatives may be used, such as ferrocene derivatives related to [BTMAP-Fc]²⁺/[BTMAP-Fc]³⁺). Example redox shuttles may further include negatively charged redox active species. One such proposed redox shuttle is ferrocyanide/ferricyanide ([Fe(CN)6]⁴⁻/[Fe(CN)6]³⁻), which is non-toxic, food safe (useful for desalinization of potable water), and highly stable; and has rapid electrochemical kinetics and negligible membrane permeability. The system may further include pumps (for example, low pressure pumps) for liquid circulation.

As shown in FIG. 1, the salt being moved from the concentrate stream 110 to the dilute stream 114 may be LiCl. Such a system may be used with various other salts, such as water-soluble ionic salts. Example cations that may be present in the salts include, but are not limited to, hydronium, lithium, sodium, potassium, magnesium, calcium, aluminum, zinc, and iron. Example anions that may be present in the salts include, but are not limited to, chloride, bromide, iodide, halide oxyanions, sulfur oxyanions, phosphorous oxyanions, and nitrogen oxyanions.

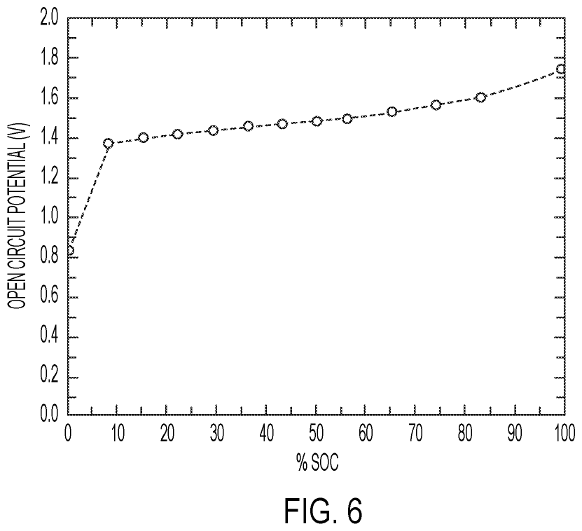

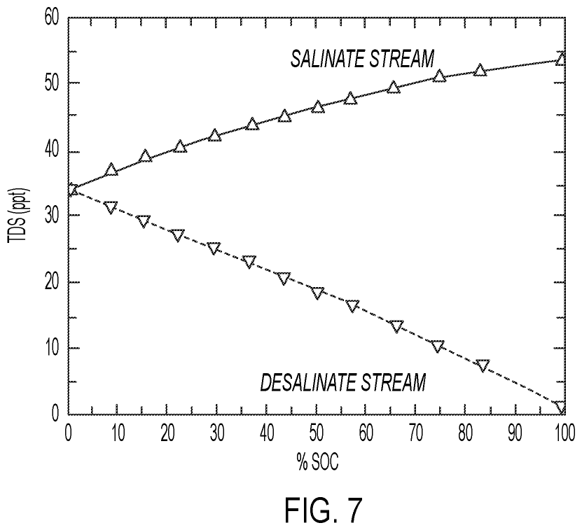

Performance results for a redox shuttle assisted electrodialysis stack, as described above, with zinc chloride/zinc metal as the anolyte and (trimethylammoniomethyl)ferrocene chloride (FcNCl) as the catholyte, are provided in FIGS. 6 and 7. In FIG. 6, a high nominal cell potential (for example, about 1.5 V) is shown, which enables high round-trip energy efficiency. FIG. 7 shows respective salinities in parts per thousand (ppt) for the salinate and desalinate streams as a function of the cell's state of charge. As can be seen, extensive salt removal from seawater solutions is possible (for example, 35 ppt to 1.4 ppt or 96% total dissolved solids removal). However, an 80% removal rate (for example, 35 ppt to about 7 ppt) is more economical. Even hypersaline brines (for example, about 100 ppt) that cannot be treated with reverse osmosis can be treated with the described redox shuttle assisted electrodialysis stack.

Note that, as shown in FIG. 7, the performance of the redox shuttle assisted electrodialysis cell is quite effective for relatively high salt concentrations, which can be useful for applications such as desalinating drinking water. Other applications, such as semiconductor processing, may require much lower salt levels than the around 1 ppt shown in FIG. 7. A redox shuttle assisted electrodialysis cell may not work efficiently at such low concentrations (for example, below 35 ppt and in some cases below 1 ppt) because at low salt concentrations the ionized streams have low conductivity and the low ion concentrations lead to mass transfer resistances.

Another technique, electrodeionization (EDI), is designed to perform electrochemical salinization/desalinization and can be used to produce continuous high-quality streams of ultrapure water. Electrodeionization combines ion exchange materials (for example, ion exchange resins) with electrodialysis. Ion exchange materials can remove ions in a solution to extremely low levels but have limited capacity and need to be chemically refreshed often. Electrodeionization incorporates a mixture of cation and anion ion exchange materials between the membranes of an electrodialysis device. This increases ionic conductivity in the space between the membranes. It also lowers mass transfer limitations since ions are transported mainly by migration instead of diffusion. Electrodeionization is subject to some of the same limitations as electrodialysis, such as activation overpotentials and destructive by-products. For example, state of the art electrodeionization systems require a water electrolysis step at the electrodes to balance the redox reactions.

Ion exchange materials may include anion exchange material (preferentially conductive to anionic species), which is configured to selectively exchange anionic species present in the material for anionic species from surrounding liquid and facilitate migration of the exchanged anionic species under an applied electric field. Ion exchange materials may also include cation exchange material (preferentially conductive to cationic species), which is configured to selectively exchange cationic species present in the material for cationic species from surrounding liquid and facilitate migration of the exchanged cationic species under an applied electric field.

Ion exchange materials may be formed of crosslinked polymer backbone (for example, crosslinked polystyrene) with an attached functional group (for example, trimethylammonium groups for anion exchange materials, and/or dimethylethanolammonium groups for anion exchange materials, and/or sulphonic acid groups for cation exchange materials).

In one or more embodiments in accordance with this disclosure, a redox shuttle assisted electrodeionization (RSAE-EDI) stack/cell combines redox shuttle assisted electrodialysis and electrodeionization. The efficiency of desalinating aqueous solutions to ultrapure levels is surprisingly improved by incorporating ion exchange materials into a redox shuttle assisted electrodialysis system. For example, the redox shuttle assisted electrodeionization stacks according to embodiments disclosed herein may be used to achieve a four-fold or greater improvement in efficiency (for example, measured in kilograms of sea water desalinated per kilowatt-hour) over both a redox shuttle assisted electrodialysis stack and an electrodeionization stack.

Preliminary performance results show that a redox shuttle assisted electrodeionization stack is more efficient than a redox shuttle assisted electrodialytic stack, in particular, when desalinating water from approximately 10 ppt. For example, preliminary performance results surprisingly show that desalinization of 1163 ppm water to 101 ppm may be achieved with an efficiency of 2750 kg of water desalinated per kilowatt-hour, which is approximately 2.4 times the efficiency seen with redox shuttle assisted electrodialysis alone and approximately 5.4 times the efficiency seen with electrodeionization alone.

As described herein, redox shuttle assisted electrodeionization combines redox shuttle assisted electrodialysis with electrodeionization by incorporating the ion exchange materials used in electrodeionization into a redox shuttle assisted electrodialysis stack. Redox shuttle assisted electrodeionization may overcome mass transport limitations of redox shuttle assisted electrodialysis at low salt concentrations and activation overpotentials of electrodeionization to produce ultrapure water at high efficiency.

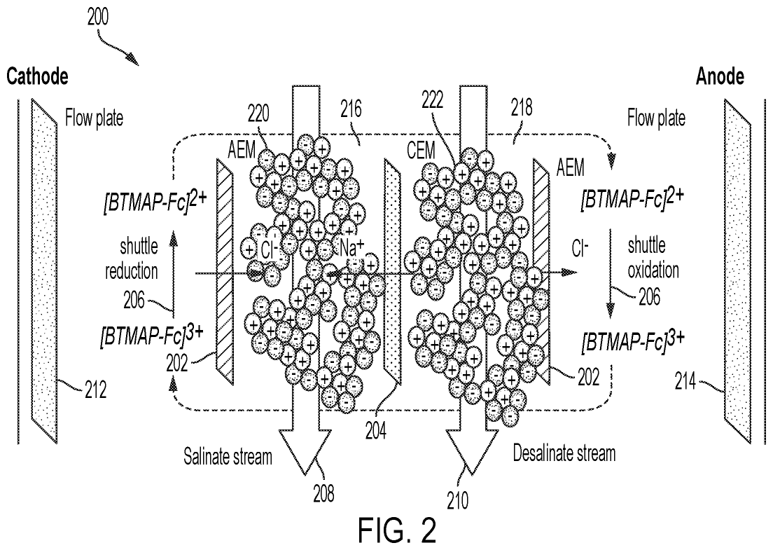

FIG. 2 shows a redox shuttle assisted electrodeionization stack 200 according to one or more embodiments. The redox shuttle assisted electrodeionization stack 200 may include two outer ion exchange membranes 202 that separate outer redox channels 206 from a concentrate stream 208 (that is, the inner salinate stream) and a dilute stream 210 (that is, the inner desalinate stream).

Redox streams may flow through the outer redox channels 206 to carry a redox shuttle (for example, a negatively charged ferrocene derivative dissolved in water). In embodiments according to FIG. 2, the outer redox channels 206 may be fluidly connected to form a redox shuttle loop to circulate the redox shuttle around the redox shuttle assisted electrodeionization stack. In embodiments with salinate/desalinate chamber pairs, such as those discussed further below, the multiple stacked chamber pairs may share a single redox shuttle loop.

In embodiments according to FIG. 2., the outer ion exchange membranes 202 are configured as anion exchange membranes (AEMs) and the central ion exchange membrane is configured as a cation exchange membrane (CEM). Examples of commercially available anion exchange membrane materials include Fumatech Fumasep® ion exchange membrane and AGC Selemion™ ion exchange membrane. Examples of commercially available cation exchange membranes include Chemours™ Nafion™ membrane and Ionomr Pemion™ proton exchange membrane. In other embodiments, the central ion exchange membrane 204 may be an anion exchange membrane with cation exchange membranes as the opposing outer ion exchange membranes 202. As shown in FIG. 2, the concentrate stream 208 and the dilute stream 210 may be separated by the central ion exchange membrane 204. In exemplary embodiments, the concentrate stream 208 may flow through a salinate channel (that is, the concentrate fluid passageway 216) and the dilute stream 210 may flow through a desalinate channel (that is, the dilute stream passageway 218).

The ion exchange membranes may be between 8 and 200 microns thick or, preferably, between 50 and 120 microns thick. Additionally or alternatively to pre-formed or commercially available ion exchange membranes, ion exchange membranes may be prepared by applying an ionomer membrane coating (for example, a layer a few microns thick) to a porous support membrane. In some embodiments, rather than the single chamber pair shown in FIG. 2, one stack may include multiple salinate/desalinate chamber pairs, such as between 5 and 10 chamber pairs, between 1 and 20 chamber pairs, or more than 20 chamber pairs. In such embodiments, desalinate/dilute streams and salinate/concentrate streams may flow through respective desalinate/dilute chambers and salinate/concentrate chambers between opposing membrane pairs (that is, for example, an anion exchange membrane and a cation exchange membrane) in parallel or the streams may flow counter to one another. Likewise, FIG. 2 shows the salinate stream 208 flowing in parallel with (that is, in the same direction as) desalinate stream 210, but the streams may flow counter to one another in other embodiments.

An external voltage (not shown) may be applied across first and second electrodes (for example, cathode 212 and anode 214) to induce oxidation or reduction in redox-active shuttle molecules, driving ion movement across the membranes 202, 204 without splitting water or producing other gaseous by products. Application of the external voltage may create two streams: the concentrate stream 208 (for example, salt water and/or hypersaline brine) and the dilute stream 210 (for example, water and/or salt water with a lower concentration of salt than the concentrate stream 208).

The concentrate fluid passageway 216 and the dilute fluid passageway 218 that carry the concentrate stream 208 and the dilute stream 210, respectively, may each also include a mixture of ion exchange materials (for example, ion exchange materials 220, 222). The mixture of ion exchange materials may be located in one or both of the concentrate fluid passageway 216 and the dilute fluid passageway 218. For example, the mixture of ion exchange materials may extend between central ion exchange membrane 204 one or both outer ion exchange membranes 202.

Additionally or alternatively, the mixture of ion exchange materials may be incorporated into one or more of the membranes 202, 204. The ion exchange materials may form or define a fixed bed or fixed media on or between the membranes 202, 204.

In FIG. 2, the ‘+’ and ‘−’ symbols in the ion exchange materials indicated respective cation exchange materials (such as cation exchange resin) and anion ion exchange materials (such as an anion exchange resin). In some embodiments there may be approximately equal anion and cation exchange materials (for example, equal anion and cation exchange materials by weight-percent, by volume, or by quantity of anions and cations). In other embodiments, a different ratio of cation to anion exchange materials (for example, entirely cation exchange materials, entirely anion exchange materials, or a 1:2 ratio of cation exchange materials and anion exchange materials) may be preferable based on the relative conductivity of the anion and cations. Still other embodiments may include a combination of different ion exchange materials such as different ion exchange materials arranged between each membrane. In some embodiments, the ion exchange material may be made of a resin and fixed between the membranes of the redox shuttle assisted electrodeionization stack (that is, a fixed, packed, and/or immobilized bed). Other forms of the ion exchange material may include irregularly shaped particles, fibers, rods, or fabrics. It may be preferred that the system employs a high enough concentration to meet a percolation threshold of each of the two ion types.

The ion exchange materials may include resin, such as resin beads of cation exchange materials and/or resin beads of anion exchange materials. Examples of commercially available resins include Purolite® UltraClean™ UCW 3700 mixed bed resin (with a 1:1 ratio of anions and cations), Purolite® Purofine® PFC100H strong acid cation resin, and/or Purolite® Purofine® PFA4000H strong base anion resin. The resin beads may be microbeads, such as microbeads having a diameter of 50 micrometers. In exemplary embodiments, the resin may make up 80 wt-% or less of the ion exchange material. The ion exchange materials may further include a binder (such as polyethylene), which may be useful for structure, rigidity, and/or immobilization of the cation and/or anion exchange materials. The binder may make up 15 wt-% or less of the ion exchange material.

In exemplary embodiments, the ion exchange materials are prepared as one or more layers or wafers (providing a fixed bed of ion exchange materials) and may be used as spacers in between membranes (for example, membranes 202, 204) of the redox shuttle assisted electrodeionization stack to maintain spacing (that is, to fill the gap) between opposing membranes. To make an ion exchange layer or wafer, a mixture of the dry ingredients may be subjected in a mold to temperatures between 60 and 170° C. at pressures between 0 and 1000 N/cm² for a time between 1 and 240 minutes to form the thin layer or wafer (for example, to a thickness between about 100 microns and about 1 mm) such that the binder immobilizes anion and cation exchange materials with respect to each other but does not substantially coat the materials, forming an electrically and ionically conductive porous material. Other methods of making an ion exchange layer or wafer include preparing a slurry of the ingredients (for example, using water, alcohol, surfactants, or a mixture thereof as the liquid portion) and injecting the slurry into a mold.

In exemplary embodiments, as shown in FIG. 2, the ion exchange wafer or layer may be porous to permit liquid flow through a long axis of the layer or wafer (for example, flow of the concentrate stream 208 through the concentrate fluid passageway 216 via pores 221 and/or flow of the dilute stream 210 through the dilute fluid passageway 218 via pores 223). In such embodiments, the ion exchange layer or wafer may be produced with randomly distributed porosity by using a pore forming agent such as sodium chloride. Additionally or alternatively, the ion exchange layer or wafer may be produced with non-random porosity by using a pore forming agent such as soluble plastics. Porosity is equivalent to void fraction or the ratio of the volume of pore space divided by the total volume. In embodiments using a pore forming agent, a layer or wafer is formed using the pore forming agent, which is then washed away after the layer or wafer is molded. Exemplary pore forming agents include a salt (for example, NaCl) or a water-soluble plastic (for example, polyvinyl alcohol). In an exemplary embodiment, the ion exchange material is produced using between 15 wt-% and 25 wt-% pore forming agent. In other embodiments, the amount of pore forming agent used may be adjusted (for example, between 10% and 80%) to optimize flow and conductivity. Additionally, or alternatively, pores may be formed in the ion exchange material using other pore forming methods such as a by using a mold with a built-in porous structure.

In one or more embodiments, the ion exchange layers or wafers may be prepared by mixing together 75% Purolite® UltraClean™ UCW 3700 mixed bed resin, 10% polyethylene (as a binder), and 15% NaCl (as a pore forming agent), compression molding the mixture for 30 minutes at 130° C. and 700 N/cm², and then washing away the NaCl.

In some embodiments, only one of the passageways (for example, concentrate fluid passageway 216 or dilute fluid passageway 218) may include an ion exchange material (for such as ion exchange materials 220 or 222). For example, if the concentration of salt (NaCl is shown in FIG. 2) is high enough in concentrate stream 208 to maintain conductivity, the ion exchange material 220 may be omitted or replaced with a standard spacer (for example, a plastic spacer that maintains a gap between opposing membranes and allows the stream to flow through). Further, as discussed in greater detail below, the redox shuttle assisted electrodeionization stack 200 may be combined with one or more other electrodialytic stacks, such as one or more redox shuttle assisted electrodeionization stacks and/or one or more redox shuttle assisted electrodialysis stacks (for example, redox shuttle assisted electrodialysis stack 112) to provide multiple stages of processing, each successive stage having lower concentrations of salt in the dilute stream. For example, the dilute stream 114 from the redox shuttle assisted electrodialysis stack 112 in FIG. 1 may be divided and conveyed into the concentrate stream 208 and the dilute stream 210 in the redox shuttle assisted electrodeionization stack 200 of FIG. 2.

In one or more embodiments, the redox shuttle assisted electrodeionization cell may include four chambers in series. Each chamber may be separated from its neighbor by an appropriate membrane. The two central chambers may contain a concentrate stream and a dilute stream, and the two outer chambers may respectively contain a cathode or an anode. Depending upon the cell design, the membranes may be ion-selective membranes such as cation exchange membranes or anion exchange membranes or other types of membranes.

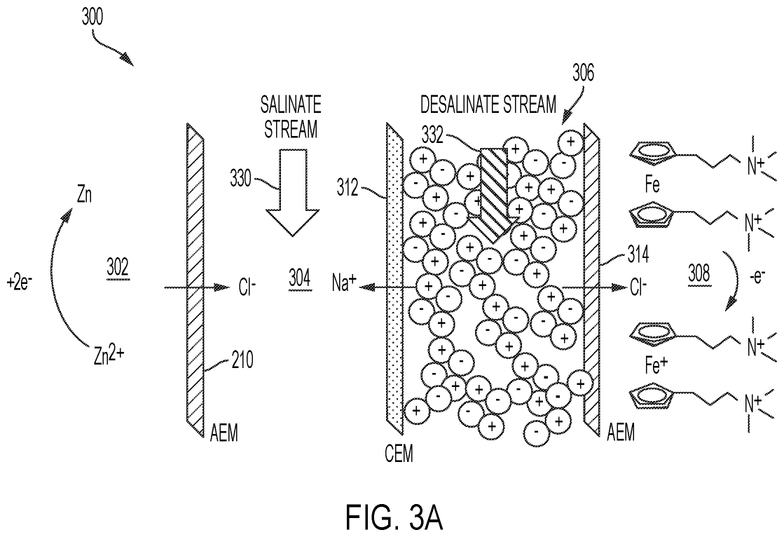

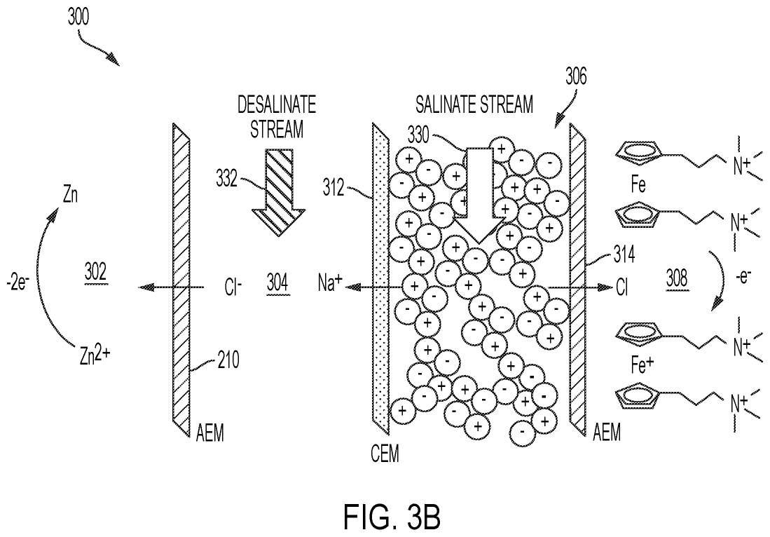

Such embodiments may be in accordance with FIG. 3A, which shows the charge half-cycle of a four-chambered redox shuttle assisted electrodeionization stack using a positively charged pair of reactants. Such embodiments may include four chambers, 302, 304, 306, and 308 as well as three membranes 310, 312, and 314. During the charge half-cycle, the salinate stream 330 flows through chamber 304 between the anolyte chamber 302 and chamber 306, which contains the desalinate stream 332. The catholyte chamber 308 is separated from chamber 306 and the desalinate stream 332 by an anion exchange membrane 314 while the anolyte chamber 302 is separated from chamber 304 and the salinate stream 330 by another anion exchange membrane 310. Chamber 304 is also separated from chamber 306 by a cation exchange membrane 312.

During the charge half-cycle, chloride and sodium ions cross membranes 310 and 312 to enter chamber 304 forming the salinate stream 330 while they cross membranes 314 and 312 to leave chamber 306 forming the desalinate stream 332. In such a four-chambered embodiment, as shown in FIGS. 3A and 3B, ion exchange materials may be incorporated between the ion exchange membranes, such as in a fixed bed.

FIG. 3B shows the same redox shuttle assisted electrodeionization stack of FIG. 3A during a discharge half-cycle. Thus, chloride and sodium ions are shown crossing membranes 310 and 312 to leave chamber 304 forming the desalinate stream 332 while they cross membranes 314 and 312 to enter chamber 306 forming the salinate stream 330. Notably, if the reactants were negatively charged, the membranes would be reversed: membranes 310, 314 would be cation exchange membranes and membrane 312 would be an anion exchange membrane. In the embodiments shown in FIGS. 3A and 3B, the anolyte is zinc and the catholyte is BTMAP-Fc. However, in other embodiments, (ferrocenylmethyl)trimethylammonium chloride (FcNCl) can be used in place of BTMAP-Fc.

Reduction of the anolyte and oxidation of the catholyte during a charge half-cycle shown in FIG. 3A moves Na⁺ and Cl⁻ ions through appropriate ion-selective membranes and into, or out of, intervening chambers that hold salt water (for example, sea water). The reverse process takes place during the discharge half-cycle shown in FIG. 3B. At all points during cycling, one of the water chambers experiences a net influx of salt while the other sees a net efflux. The energy required to affect the desalinization is simply the difference in energy input during the charging half-cycle and the energy recovered during discharge half-cycle.

The anolytes and catholytes are not restricted to the above-described embodiments. The redox-active component of the anolyte and/or catholyte can be an aqueous solution of any combination of the following, in one or more of their oxidation states, as their ions or oxocations or oxoanions and/or complexed to ligand(s): titanium(III), titanium(IV), vanadium(II), vanadium(III), vanadium(IV), vanadium(V), chromium(II), chromium(III), chromium(VI), manganese(II), manganese(III), manganese(VI), manganese(VII), iron(II), iron(III), iron (VI), cobalt(II), cobalt(III), nickel(II), copper(I), copper(II), zinc(II), ruthenium(II), ruthenium(III), tin(II), tin(IV), cerium(III), cerium(IV), tungsten(IV), tungsten(V), osmium(II), osmium(III), lead(II), zincate, aluminate, chlorine, chloride, bromine, bromide, tribromide, iodine, iodide, triiodide, polyhalide, halide oxyanion, sulfide, polysulfide, sulfur oxyanion, ferrocyanide, ferricyanide, a quinone derivative, an alloxazine derivative, a flavin derivative, a viologen derivative, a ferrocene derivative, any other metallocene derivative, a nitroxide radical derivative, a N,N-dialkyl-N-oxoammonium derivative, a nitronyl nitroxide radical derivative, and/or polymers incorporating complexed or covalently bound components of any of the aforementioned species.

The anolyte and catholyte may also include an aqueous solution of the components of a pH buffer that may or may not be redox-active under typical operating conditions. In certain aqueous embodiments, the pH of the anolyte and catholyte is matched to the pH of the electrolyte in the central chambers, which may, for example, be near neutral (pH 5-9) for water desalinization, acidic (pH 0-5) for treating acidic wastewater, or alkaline (pH 9-14) for treating alkaline wastewater. In some embodiments, it can be advantageous for the anolyte pH to be slightly lower than the other chambers such as when the anolyte is zinc/zinc chloride. In further embodiments, the pH of each of the electrolytes in the system is substantially the same within the electrochemical cell. In still further embodiments, the anolyte, catholyte, and water each has a pH between and including 3-10. Thus, the cell may include a pH monitoring and adjustment system for periodic and/or continuous pH monitoring and adjustment.

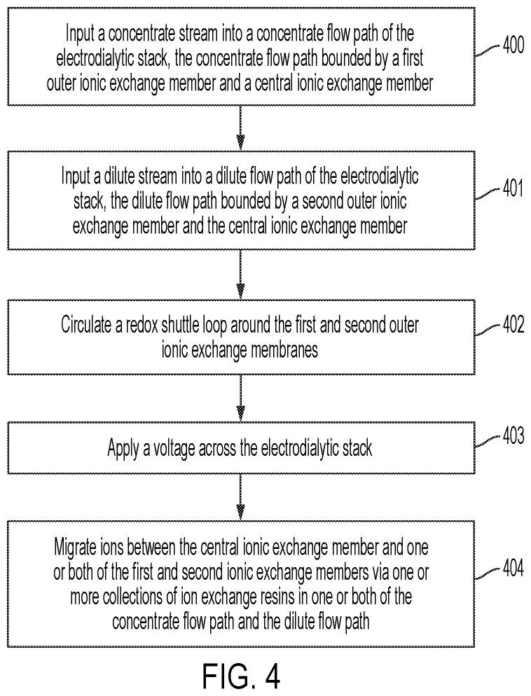

In FIG. 4, a flowchart shows a method according to an example embodiment. The method involves inputting 400 a concentrate stream into a concentrate flow path of an electrodialytic stack. The concentrate flow path may be bounded by a first outer ion exchange membrane and a central ion exchange membrane. A dilute stream may be input 201 to a dilute flow path of the electrodialytic stack. The dilute flow path may be bounded by a second outer ion exchange membrane and the central ion exchange membrane. A redox shuttle loop may be circulated 402 around the first and second outer ion exchange membranes.

A voltage may be applied 403 across the electrodialytic stack, to migrate ions between the central ion exchange membrane 204 and one or both of the first and second ion exchange membranes via at least one collection of ion exchange materials in at least one of the concentrate flow path and the dilute flow path.

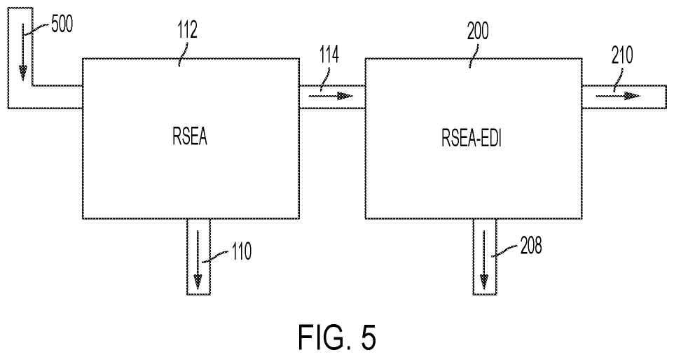

As shown in FIG. 5 and as discussed briefly above, a redox shuttle assisted electrodeionization stack may be combined modularly with one or more other ion transfer systems for transferring ions between streams (for example, redox shuttle assisted electrodeionization stacks, electrodialytic systems, redox shuttle assisted electrodialysis stacks, and/or other ion transfer systems, such as a reverse osmosis system) to provide multiple stages of processing. Modular combination of redox shuttle assisted electrodeionization stack(s) with other ion transfer systems may be useful, for example, for desalinization of hypersaline brine down to ultrapure levels at high efficiency. In exemplary embodiments, a redox shuttle assisted electrodeionization stack may provide a “finishing” step (that is, to desalinate from an intermediate salinity to a target salinity lower than the intermediate salinity) in a modular assembly of one or more additional ion transfer systems.

In FIG. 5, a block diagram shows how a conventional redox shuttle assisted electrodialysis stack can be combined with a redox shuttle assisted electrodeionization stack according to an example embodiment. With such a modular assembly, a redox shuttle assisted electrodeionization stack may be used in combination with a redox shuttle assisted electrodialytic stack to achieve efficiency comparable to the efficiency of a reverse osmosis system without the need for a high-pressure system (unlike reverse osmosis). A redox shuttle assisted electrodialysis stack (for example, redox shuttle assisted electrodialysis stack 112 shown in FIG. 1) may take a feed stream 500 and output the concentrate stream 110 and the dilute stream 114. The feed stream 500 may be split and sent through both chambers 128a, 128b of the redox shuttle assisted electrodialysis stack 112, or a separate stream (not shown) may be sent into the concentrate stream chamber 128a. The concentrate stream 110 may include salt and may be discarded and/or processed elsewhere to recover the solvent.

The dilute stream 114 may be sent from the redox shuttle assisted electrodialysis stack 112 to the redox shuttle assisted electrodeionization stack 200, where the latter may produce a second dilute stream 210 with lower concentration of solutes than the dilute stream 114. As with the redox shuttle assisted electrodialytic stack 112, the redox shuttle assisted electrodeionization stack 200 may produce a second concentrate stream 208 that may be discarded, reused, etc. In one or more embodiments, the second concentrate stream 208 produced by the redox shuttle assisted electrodeionization stack 200 may be returned to the redox shuttle assisted electrodialysis stack 112 for further processing.

In some embodiments, the redox shuttle assisted electrodialysis stack 112 and the redox shuttle assisted electrodeionization stack 200 may each have an independent redox shuttle loop. In other embodiments, the redox shuttle assisted electrodialysis stack 112 and the redox shuttle assisted electrodeionization stack 200 may share a redox shuttle loop. For example, the redox shuttle loop of the redox shuttle assisted electrodialysis stack 112 may be in fluid communication with the redox shuttle loop of the redox shuttle assisted electrodeionization stack 200. In still further embodiments, multiple redox shuttle assisted electrodialysis stacks and/or redox shuttle assisted electrodeionization stacks may all share a redox shuttle loop.

The redox shuttle assisted electrodialysis stack 112 may start with high concentrations (for example, up to 100 parts per thousand (ppt), up to 700 ppt, or more than 700 ppt). In exemplary embodiments, the system shown in FIG. 5 may be estimated to dilute the feed stream 500 from 700 ppt to less than 1 ppt (for example, less than 400 parts per million (ppm), less than 100 ppm, less than 10 ppm, less than 1 ppm, less than 400 parts per billion (ppb), less than 100 ppb, less than 10 ppb, and/or less than 1 ppb) at the output dilute stream 210. The addition of redox shuttle assisted electrodialysis to electrodeionization may increase the efficiency of electrodeionization in making ultrapure water (<1 ppb). The addition of ion exchange materials to redox shuttle assisted electrodialysis in accordance with this disclosure may increase the efficiency of electrodialysis desalinization to compete with reverse osmosis in the ranges where reverse osmosis is currently more efficient than electrodialytic methods (for example, around 35ppt to 1 ppt).

In one or more embodiments, multiple redox shuttle assisted electrodeionization stacks may be modularly couplable to one another and/or to redox shuttle assisted electrodialysis stacks and/or to other ion transfer systems. In such embodiments, multiple redox shuttle assisted electrodialysis stacks may also be modularly couplable to one another and/or to redox shuttle assisted electrodeionization stacks. For example, each redox shuttle assisted electrodeionization stack may include a concentrate inlet and a concentrate outlet, each in fluid communication via the redox shuttle assisted electrodeionization stack's respective concentrate flow path. Each redox shuttle assisted electrodeionization stack may further include a dilute inlet and a dilute outlet, each in fluid communication via the redox shuttle assisted electrodeionization stack's respective dilute flow path.

The redox shuttle assisted electrodeionization stack may still further include a feed stream pathway to convey water to be processed by the redox shuttle assisted electrodeionization stack into the concentrate flow path via the concentrate inlet and/or into the dilute flow path via the dilute inlet. The feed stream pathway may further be configured to couple with at least one of the concentrate outlet of the redox shuttle assisted electrodeionization stack, the dilute outlet of the redox shuttle assisted electrodeionization stack, or a feed stream. That is to say, the feed stream pathway may be used to select the source of water to be processed, such as from a natural source (for example, a sea water source), from the redox shuttle assisted electrodeionization stack's own concentrate stream (for example, to be mixed with a natural source and further processed), or from another redox shuttle assisted electrodeionization stack's dilute stream (for example, to further desalinate water desalinated by the preceding redox shuttle assisted electrodeionization stack). Likewise, the feed stream pathway of a subsequent redox shuttle assisted electrodeionization stack may convey water from the prime redox shuttle assisted electrodeionization stack to be further desalinated. Other ion transfer systems may likewise be modularly couplable to the redox shuttle assisted electrodeionization system using a modular flow pathway (such as a conduit, hose, channel, pipe, or other means of fluid coupling).

Any number of additional modular configurations may be made in accordance with the present disclosure, for example, assemblies to desalinate to below 100 ppb (such as for use in semiconductor processing), assemblies to produce potable drinking water, and/or assemblies to regenerate liquid desiccant (such as to 100 ppm).

In one or more embodiments, one or more redox shuttle assisted electrodeionization stacks may be coupled with one or more other ion transfer systems. For example, one or more redox shuttle assisted electrodeionization stacks may be modularly coupled to one or more redox shuttle assisted electrodialytic stacks. In another example, one or more redox shuttle assisted electrodeionization stacks may be modularly coupled to one or more electrodeionization systems. In still another example, one or more redox shuttle assisted electrodeionization stacks may be modularly coupled to one or more reverse osmosis systems.

In other embodiments according to this disclosure, a redox shuttle assisted electrodeionization stack may be coupled with two or more other ion transfer systems. For example, one or more redox shuttle assisted electrodeionization stacks may be modularly coupled to one or more redox shuttle assisted electrodialytic stacks and one or more electrodeionization systems. In another example, one or more redox shuttle assisted electrodeionization stacks may be modularly coupled to one or more redox shuttle assisted electrodialytic stacks and one or more reverse osmosis systems. In yet another example, one or more redox shuttle assisted electrodeionization stacks may be modularly coupled to one or more electrodeionization systems and one ore more reverse osmosis systems.

In still other embodiments, a redox shuttle assisted electrodeionization stack may be coupled with three or more other ion transfer systems. For example, one or more redox shuttle assisted electrodeionization stacks may be modularly coupled to one or more redox shuttle assisted electrodialytic stacks, one or more electrodeionization systems, and one or more reverse osmosis systems.

In exemplary embodiments, modularly couplable electrolytic stacks may be coupled in series to desalinate sea water-which is typically 3.5 wt-% (35 ppt TDS)—to the level of potable drinking water (typically between 100 ppm and 300 ppm TDS). In such embodiments, sea water (35 ppt brine) may be filtered to remove particulates and then conveyed into a redox shuttle assisted electrodialysis stack via the stack's feed stream pathway. With voltage applied across the redox shuttle assisted electrodialysis stack, the 35 ppt brine may be desalinated to 10 ppt in the dilute stream emerging from the dilute output of the redox shuttle assisted electrodialysis stack. The dilute output of the redox shuttle assisted electrodialysis stack may be coupled to a feed stream pathway of a redox shuttle assisted electrodeionization stack (for example, including ion exchange material in its dilute flow path), which may thereby convey the 10 ppt water into the redox shuttle assisted electrodeionization stack. With voltage applied across the redox shuttle assisted electrodeionization stack, the 10 ppt water may be further desalinated to 100 ppm (that is, potable drinking water) in the dilute stream emerging from the dilute output of the redox shuttle assisted electrodeionization stack.

In other applications, such as for producing industrial-grade high purity water, the dilute output of the redox shuttle assisted electrodeionization stack may be coupled to feed stream pathways of subsequent redox shuttle assisted electrodeionization stacks, which may operate to further desalinate the 100 ppm water. With such modular assemblies, a redox shuttle assisted electrodeionization stack may be used in combination with one or more reverse osmosis system to achieve comparable efficiency with reduced need for high-pressure when compared to a reverse osmosis system, alone. In an exemplary embodiment, a first sea water desalinization step may be accomplished by a reverse osmosis system. For example, a reverse osmosis system may desalinate sea water to 10 ppt in a dilute stream, which may be further desalinated (that is, finished) by a redox shuttle assisted electrodeionization stack to 100 ppm.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (for example, 1 to 5 includes 1, 1.5, 2, 2.75, 3, 3.80, 4, and 5) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

### Examples

These examples are merely for illustrative purposes only and are not meant to be limiting on the scope of the appended claims. All parts, percentages, ratios, etc. in the examples and the rest of the specification are by weight, unless noted otherwise. The following abbreviations are used here: m=meter; cm=centimeter; mm=millimeter; cm²=square centimeter; cm³=cubic centimeter; A=amp; V=volt; m³=cubic meter; kWh=kilowatt hour; PPM=parts per million; min=minute; L=liter; h=hour; ml=milliliter; EDI=electro deionization; NA=not applicable; SEC=specific energy consumption; LiCl=lithium chloride.

The performance of various types of electrochemical desalinization devices were tested and comparatively evaluated. The devices were tested to determine the specific energy consumption (SEC) for water desalinization and electrochemical performance.

Test Methods

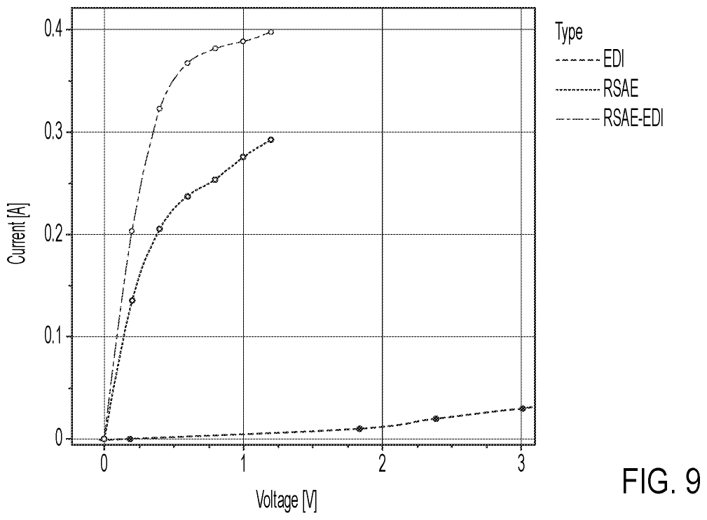

Method 1: Polarization Curve A graph showing electrochemical current measured as a function of voltage is shown in FIG. 9. Voltage was set and current was measured using a Biologic potentiostat (SP-150) connected to the electrical leads of each tested device. Voltage was varied from 0 V to 3 V or until a limiting current was reached. A nominal 1000 ppm lithium chloride (Sigma) aqueous solution was used as the inlet feed. Concentration was measured using a Thermo Scientific STAR A212 Conductivity Benchtop Meter Kit with a WTW TetraCon 925 IDS Conductivity Probe. Flow rates were measured with Bronkhorst mini CORI-FLOW™ M14 Coriolis meters.

### Method 2: Specific Energy Consumption

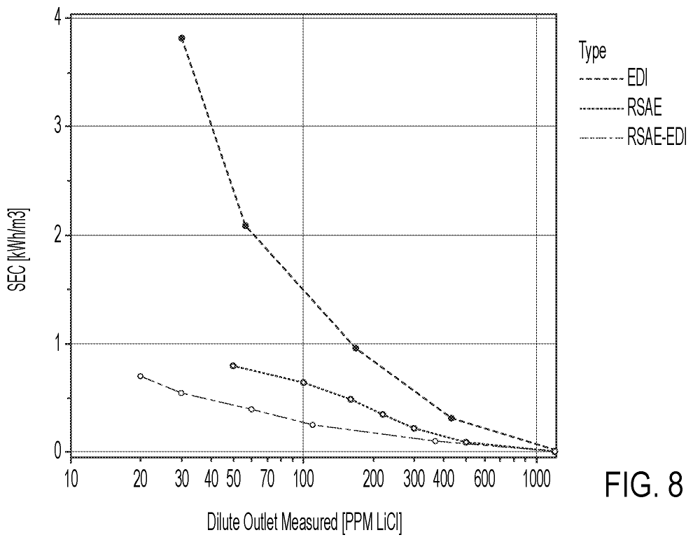

A graph showing specific energy consumption measured as a function of dilute outlet concentration is shown in FIG. 8. Energy use was calculated as the product of current and voltage as measured using a Biologic potentiostat (SP-150). A nominal 1000 ppm lithium chloride (Sigma Aldrich) aqueous solution was used as the inlet feed. Dilute outlet concentration was measured using a Thermo Scientific STAR A212 Conductivity Benchtop Meter Kit with a WTW TetraCon 925 IDS Conductivity Probe. Flow rates were measured with Bronkhorst mini CORI-FLOW™ M14 Coriolis meters.

Sample Preparation

The RSAE-EDI device was a redox shuttle assisted electrodeionization stack in accordance with this disclosure using commercially available anion and cation exchange membranes (from AGC Chemicals Americas, Inc. Exton, Pa.) and ion exchange wafers (prepared as described below). The example ion exchange wafers contained 10 wt-% polyethylene binder, 10 wt-% sodium chloride as a pore forming agent, and 80 wt-% Purolite UCW 3700 UltraClean Mixed Bed Resin. The ion exchange wafers were nominally 0.4 mm thick. The wafers were used in each salinate and desalinate chamber.

The EDI device was an electrodeionization module used in a commercially available water deionization device (Milli-Q Elix® EDI Module 10 L/h).

The RSAE device was a redox shuttle assisted electrodialysis device using commercially available anion and cation exchange membranes (AGC).

The RSAE-EDI and EDI devices each had a nominal active area of 200 cm². The RSAE device had a nominal active area of 800 cm².

TABLE 1
Devices tested.

| Device ID | Type |
|---|---|
| RSAE-EDI | Redox shuttle assisted electrodeionization |
| EDI | Commercial electrodeionization |
| RSAE | Redox shuttle assisted electrodialysis |

The following materials were used to prepare the ion exchange wafer used in the RSAE-EDI device.

TABLE 2
Materials used.

| Material | Material type | Source |
|---|---|---|
| UCW 3700 | Ion exchange resin | Purolite |
| UltraClean Mixed | | |
| Bed Resin | | |
| High density | Binder | Sigma Aldrich |
| polyethylene | | |
| Sodium chloride | Pore forming agent | Sigma Aldrich |

Sample Testing

The RSAE-EDI device and comparative devices (the EDI device and the RSAE device) were tested using Method 1: Polarization curve and Method 2: Specific energy consumption as described above. A nominal flow rate of 5 ml/min was used for the RSAE-EDI device and the RSAE device. A nominal flow rate of 15 ml/min was used for the EDI device for all methods. A nominal 1000 ppm lithium chloride (Sigma) aqueous solution was used as the inlet feed for all tests.

Results

The results of Method 1 and Method 2 are shown in are shown in Table 3.

TABLE 3
Device performance.

| | Current at | Limiting | SEC to reach 100 |
|---|---|---|---|
| Device ID | 0.2 V, (A) | current, (A) | PPM LiCl, (kWh/m³) |
| RSAE-EDI | 0.203 | 0.397 | 0.270 |
| EDI | 0.0 | NA | 1.47 |
| RSAE | 0.135 | 0.292 | 0.635 |

From Method 1 it was observed that the RSAE-EDI device has a higher current for the same voltage than the EDI device and the RSAE device. Additionally, the RSAE-EDI device starts to produce a non-zero current at a lower voltage than the EDI device. the RSAE-EDI device can also reach a higher limiting current than the RSAE device. A limiting current was not seen for the EDI device below 3 V. FIG. 9 shows the full results of this test for the measured current at several voltage levels.

From Method 2 it was observed that the RSAE-EDI device has a lower specific energy consumption (SEC) for diluting salt streams from 1000 ppm to 100 ppm than the EDI device and the RSAE device. In this example the SEC of the RSAE-EDI device was 5.4 times less than for the EDI device and 2.4 times less than for the RSAE device. FIG. 8 shows the full result of this test for the specific energy consumption required to desalinate a nominal 1000 ppm LiCl inlet to several outlet concentrations.

It was concluded from the test results of the RSAE-EDI device compared to the EDI device and the RSAE device that redox shuttle assisted electrodeionization can outperform redox shuttle assisted electrodialysis and commercial electrodeionization systems. Redox shuttle assisted electrodeionization shows lower resistance to salt transport than either redox shuttle assisted electrodialysis or commercial electrodeionization systems. Redox shuttle assisted electrodeionization can also overcome mass transport limitations in redox shuttle assisted electrodialysis leading to a higher limiting current. Redox shuttle assisted electrodeionization can also overcome the minimum voltage barrier required in commercial electrodeionization systems. These trends are expected to remain true over a wide range of inlet and outlet salt concentrations.

1. An electrodialytic stack comprising:
a concentrate flow path bounded by a central ion exchange membrane and a first outer ion exchange membrane of a different type than the central ion exchange membrane, wherein a concentrate stream moves through the concentrate flow path;
a dilute flow path bounded by the central ion exchange membrane and a second outer ion exchange membrane of a different type than the central ion exchange membrane, wherein a dilute stream moves through the dilute flow path;
a redox shuttle loop separated from the concentrate stream by the first outer ion exchange membrane and separated from the dilute stream by the second outer ion exchange membrane;
a first electrode and a second electrode operable to apply a voltage across the electrodialytic stack; and
at least one collection of ion exchange materials in at least one of the concentrate flow path and the dilute flow path, wherein the at least one collection of ion exchange materials migrates ions between the central ion exchange membrane and at least one of the first and second outer ion exchange membranes.

2. The electrodialytic stack of claim 1, wherein the at least one collection of ion exchange materials comprises a first collection of ion exchange materials located in the concentrate flow path and a second collection of ion exchange materials located in the dilute flow path.

3. The electrodialytic stack of claim 1, wherein the at least one collection of ion exchange materials comprises a cation exchange material and an anion ion exchange material.

4. The electrodialytic stack of claim 1, wherein the at least one collection of ion exchange materials comprises an ion exchange resin.

5. The electrodialytic stack of claim 1, wherein the at least one collection of ion exchange materials comprises a binder.

6. The electrodialytic stack of claim 1, wherein the at least one collection of ion exchange materials comprises at least one packed bed.

7. The electrodialytic stack of claim 1, wherein the at least one collection of ion exchange materials is incorporated into at least one of the first outer ion exchange membrane, the second outer ion exchange membrane, and the central ion exchange membrane.

8. The electrodialytic stack of claim 1, wherein the central ion exchange membrane comprises an anion exchange membrane and wherein the first and second outer ion exchange membranes comprise cation exchange membranes.

9. The electrodialytic stack of claim 1, wherein the central ion exchange membrane comprises a cation exchange membrane and wherein the first and second outer ion exchange membranes comprise anion exchange membranes.

10. The electrodialytic stack of claim 1, wherein the redox shuttle loop comprises a negatively charged redox active species.

11. The electrodialytic stack of claim 1, wherein the redox shuttle loop comprises ferrocyanide/ferricyanide ([Fe(CN)₆]⁴⁻/[Fe(CN)₆]³⁻) or a negatively charged ferrocene derivative.

12. The electrodialytic stack of claim 1, wherein the redox shuttle loop comprises a positively charged redox active species.

13. The electrodialytic stack of claim 1, wherein the redox shuttle loop comprises bis(trimethylammoniopropyl) ferrocene/bis(trimethylammoniopropyl) ferrocenium ([BTMAP-Fc]²⁺/[BTMAP-Fc]³⁺) or a positively charged ferrocene derivative.

14. The electrodialytic stack of claim 1, wherein the redox shuttle loop comprises:
a first redox stream separated from the concentrate stream by the first outer ion exchange membrane; and
a second redox stream separated from the dilute stream by the second outer ion exchange membrane.

15. The electrodialytic stack of claim 14, wherein the first redox stream is in fluid communication with the second redox stream.

16. An ion transfer system comprising:
at least one ion transfer module comprising:
a modular dilute inlet in fluid communication with a modular dilute outlet; and
a modular concentrate inlet in fluid communication with a modular concentrate outlet; and
at least one redox shuttle assisted electrodeionization stack comprising:
a concentrate flow path comprising a concentrate inlet in fluid communication with a concentrate outlet, the concentrate flow path bounded by a central ion exchange membrane and a first outer ion exchange membrane of a different type than the central ion exchange membrane, wherein a concentrate stream moves through the concentrate flow path;
a dilute flow path comprising a dilute inlet in fluid communication with a dilute outlet, the dilute flow path bounded by the central ion exchange membrane and a second outer ion exchange membrane of a different type than the central ion exchange membrane, wherein a dilute stream moves through the dilute flow path;
a feed flow path in fluid communication with at least one of the concentrate inlet and the dilute inlet, the feed flow path fluidly couplable to at least one of the concentrate outlet, the dilute outlet, the modular dilute outlet, and the modular concentrate outlet;
a redox shuttle loop separated from the concentrate stream by the first outer ion exchange membrane, the redox shuttle loop separated from the dilute stream by the second outer ion exchange membrane;
a first electrode and a second electrode operable to apply a voltage across the at least one redox shuttle assisted electrodeionization stack; and
at least one collection of ion exchange materials in at least one of the concentrate flow path and the dilute flow path, wherein the at least one collection of ion exchange materials migrates ions between the central ion exchange membrane and at least one of the first and second outer ion exchange membranes.

17. The ion transfer system of claim 16, wherein the at least one ion transfer module comprises a second redox shuttle assisted electrodeionization stack.

18. The ion transfer system of claim 16, wherein the at least one ion transfer module comprises a redox shuttle assisted electrodialytic stack.

19. The ion transfer system of claim 16, wherein the at least one ion transfer module comprises a reverse osmosis system.

20. The ion transfer system of claim 16, wherein the at least one ion transfer module comprises an electrodeionization system.

21. A method comprising:
inputting a concentrate stream into a concentrate flow path of an electrodialytic stack, the concentrate flow path bounded by a first outer ion exchange membrane and a central ion exchange membrane;
inputting a dilute stream into a dilute flow path of the electrodialytic stack, the dilute flow path bounded by a second outer ion exchange membrane and the central ion exchange membrane;
circulating a redox shuttle loop around the first and second outer ion exchange membranes;
applying a voltage across the electrodialytic stack; and
migrating ions between the central ion exchange membrane and at least one of the first and second outer ion exchange membranes via at least one collection of ion exchange materials in at least one of the concentrate flow path and the dilute flow path.

22. The method of claim 21, wherein the at least one collection of ion exchange materials comprises a first collection of ion exchange materials located in the concentrate flow path and a second collection of ion exchange materials located in the dilute flow path.

23. The method of claim 21, wherein the at least one collection of ion exchange materials comprises a cation exchange material and an anion exchange material.

24. The method of claim 21, wherein the at least one collection of ion exchange materials comprises an ion exchange resin.

25. The method of claim 21, wherein the at least one collection of ion exchange materials comprises at least one packed bed.

26. The method of claim 21, wherein the at least one collection of ion exchange materials is incorporated into at least one of the first outer ion exchange membrane, the second outer ion exchange membrane, and the central ion exchange membrane.

27. The method of claim 21, wherein the central ion exchange membrane comprises an anion exchange membrane and wherein the first and second outer ion exchange membranes comprise cation exchange membranes.

28. The method of claim 21, wherein the central ion exchange membrane comprises a cation exchange membrane and wherein the first and second outer ion exchange membranes comprise anion exchange membranes.

29. The method of claim 21, wherein the redox shuttle loop comprises a negatively charged redox active species.

30. The method of claim 21, wherein the redox shuttle loop comprises ferrocyanide/ferricyanide ([Fe(CN)₆]⁴⁻/[Fe(CN)₆]³⁻) or a negatively charged ferrocene derivative.

31. The method of claim 21, wherein the redox shuttle loop comprises a positively charged redox active species.

32. The method of claim 21, wherein the redox shuttle loop comprises bis(trimethylammoniopropyl) ferrocene/bis(trimethylammoniopropyl) ferrocenium ([BTMAP-Fc]²⁺/[BTMAP-Fc]³⁺) or a positively charged ferrocene derivative.
